(19) United States
(12) Patent Application Publication
(10) Pub. No.: US 2008/0319814 A1
(43) Pub. Date: Dec. 25, 2008

(54) Quality Control Inspection and Maintenance Result Reporting System

(76) Inventor: Cooper S.K. KUO, Taipei City (TW)

Correspondence Address: HDSL, P.O. BOX 220746, CHANTILLY, VA, 20153-0746, US

(21) Appl. No.: 12/137,222

(22) Filed: Jun. 11, 2008

Related U.S. Application Data
(63) Continuation-in-part of application No. 10/608,035, filed on Jun. 30, 2003, now abandoned.

(51) Int. Cl. G06Q 10/00

(52) U.S. Cl. 705/7

(57) ABSTRACT

A quality control (QC) inspection and maintenance result reporting system includes a web server, and an inspection database. The web server has various selection and analysis webpages built therein, and the inspection database has quantity analysis reports, production analysis reports, inspection result reports, QC personnel data, unqualified data and photographs for each type of product, and analysis reports for the rates of unqualified and qualified products stored therein. The registrar can be connected with the web server through the Internet. The web server can determine the registrar's privilege, according to the registering account and password, can display webpages for the registrar to select conditional options, according to the registrar's privilege, and can retrieve the requested reports from the inspection database for the registrar to view, according the selection made by the registrar, so that the registrar can know of QC inspection and maintenance results and the relevant QC personnel data in real time.

### RELATED APPLICATIONS

This application is a continuation-in-part of U.S. patent application Ser. No. 10/608,035, filed on Jun. 30, 2003.

### BACKGROUND OF THE INVENTION

1. Field of the Invention

The present invention relates to a quality control (QC) inspection and maintenance result reporting system and, particularly, to a QC inspection and maintenance result reporting system that can serve the client placing the order to fill out order placing data and to know of QC inspection and maintenance results for the products in real time by means of the webpages displayed form a remote web server, as the client is connected with the web server through the Internet.

2. Descriptions of the Related Art

In the past, the client usually places order by means of telephone or fax, informing the manufacture about the required quantity of articles to make. As the articles have been made up, they are presented to the client for quality control; the delivery may be done if there is not any unqualified product. When the client commissions an outland manufacturer to produce the articles, he cannot often watch the production in situ. The client, who places the order, must commissions a QC company in the region local to the manufacturer for quality inspection. The QC company should serve the client with an attitude of profession, fairness, justice and fervidity. The QC company, upon receiving the order, will go to the manufacturer to undertake the quality control according to the specification set by the client. The QC inspection result will be kept in paper format and delivered to the client by fax, post or E-mail, so that the client may have an idea about the rates of unqualified and qualified products and the causes for the unqualification. However, such a way of communication is too slow to meet the tempo of modern tide with the speedy development of technology. The Internet may provide a way by which the trade mechanism can be performed for order placing and the QC results can be input to the network in real time. In this way, the client placing the order, the QC company and the manufacturer under quality control each can realize and control the QC the quality analysis of the articles and even can analyze the conditions of the unqualified products. Function of historical data search and analysis may be provided, also. Since the causes for unqualification is known, they can be used as a basis for development and process improvement.

Since the convention has such drawbacks as described above, it is not a good one. An improvement is required urgently.

In view of the above difficulties associated with the conventional way of order placing, the present inventor, through a long-term study and practice, has set about the work of improvement and innovation that provides the present QC inspection and maintenance result reporting system.

### SUMMARY OF THE INVENTION

The primary objective of this invention is to provide a QC inspection and maintenance result reporting system that may serve the client placing the order to fill out order placing data by means of the webpages displayed form a remote web server, as the client is connected with the web server through the Internet. In this way, the filled out data may be stored in an inspection database so that the commissioned QC company may undertake inspection, test, classification, rework and maintenance in situ, according to the direction of order placing; the QC results may be stored in the inspection database through the web server, so that the client placing the order may view the rates of unqualified and qualified products and the causes for the unqualification to realize and control the quality of the products, just being connected with the web server through the Internet.

Another objective of this invention is to provide a QC inspection and maintenance result reporting system that may upload the analysis reports and photographs to an inspection database, for the registrar to download and view.

Yet a further objective of this invention is to provide a QC inspection and maintenance result reporting system that may serve the financial supervisor or boss of the commissioned QC company to view the QC results and the finance reports of the articles through the web server.

A QC inspection and maintenance result reporting system fulfilling the above objectives comprises a web server and an inspection database. The web server has a determination unit, an order input unit, a data maintenance unit, an upload/download unit, and a QC personnel status check unit built therein. The determination unit is used for determining the status of the registrar so as to define the registrar's privilege. The order input unit is used for the registrar to fill out order placing data and is used for storing the filled out order placing data in the inspection database so that the commissioned QC company may undertake inspection, test, classification, rework and maintenance in situ, according to the direction of order placing. The data maintenance unit is used for the QC personnel to store the inspection, test, classification, rework and maintenance results and the QC personnel data in the inspection database so that the registrar within his privilege may view the QC and analysis results, with which he may view the ratio and analysis between the rates of qualified and unqualified products and may realize the causes for the unqualification. The upload/download unit is used for uploading data and photographs to the inspection database, for the registrar to download. The QC personnel status check unit is used for storing the QC personnel data in the inspection database. Also, the boss of the commissioned QC company may view the charge on the whole commission so as to realize the revenue.

### BRIEF DESCRIPTION OF THE DRAWINGS

The drawings disclose an illustrative embodiment of the present invention which serves to exemplify the various advantages and objects hereof, and are as follows.

FIG. 1 is a block diagram of the QC inspection and maintenance result reporting system of the present invention.

FIG. 2 is a block diagram of the data maintenance unit of the QC inspection and maintenance result reporting system of the present invention.

FIG. 3 is a flow chart of the registration, which is done by the client placing the order, into the QC inspection and maintenance result reporting system of the present invention.

FIG. 4 is a flow chart of the registration, which is done by the QC personnel, into the QC inspection and maintenance result reporting system of the present invention.

FIG. 5 is a flow chart of the inspection result analysis in the QC inspection and maintenance result reporting system of the present invention.

FIG. 6 is a flow chart of the inspection result input in the QC inspection and maintenance result reporting system of the present invention.

### DESCRIPTION OF THE PREFERRED EMBODIMENT

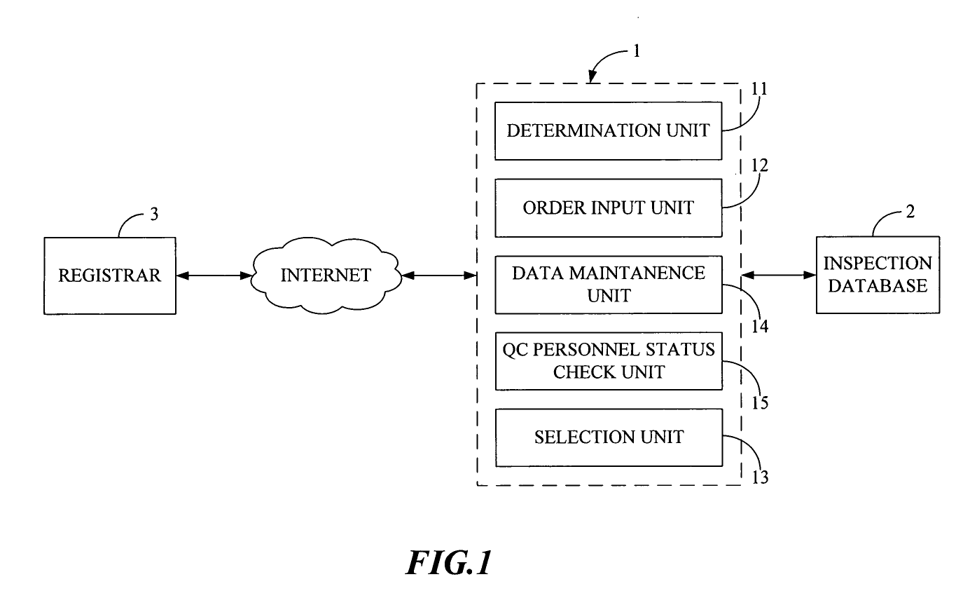

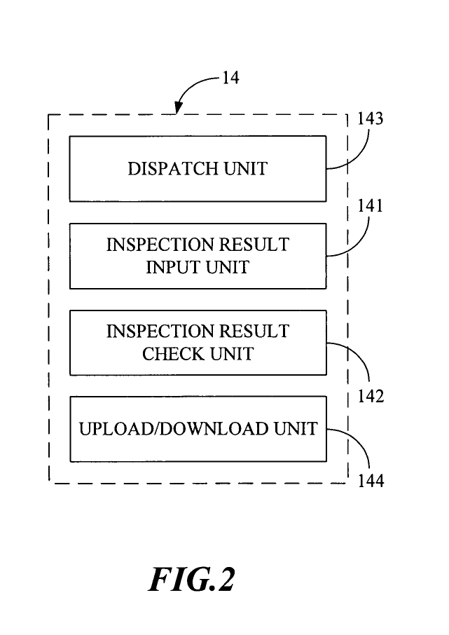

Refer to FIG. 1 and FIG. 2, which are the block diagrams of the QC inspection and maintenance result reporting system of the present invention. As shown, the system comprises a web server 1, and an inspection database 2. The inspection database 2 has quantity analysis reports, production analysis reports, inspection result reports, QC personnel data, inspection data for each type of product, and analysis reports for the rates of unqualified and qualified products stored therein. The web server 1 has a determination unit 11, an order input unit 12, a selection unit 13, a data maintenance unit 14, and a QC personnel status check unit 15 built therein.

The determination unit 11 is used for determining the status of a registrar 3 so as to define his privilege as for a client placing the order, a financial supervisor or boss of the commissioned QC company, or a manufacturer under QC. The order input unit 12 is used for the registrar to fill out order placing data and is used for storing the filled out order placing data in the inspection database 1 so that the commissioned QC company can undertake inspection, test, classification, rework and maintenance in situ. The selection unit 13 is used for the registrar 3 to select conditional options as desired. The data maintenance unit 14 comprises an inspection result input unit 141, an inspection result check unit 142, a dispatch unit 143, and an upload/download unit 144. The dispatch unit 143 is used for generating dispatch lists, with which the QC personnel can undertake inspection for the products in situ, according to the direction of order input unit 12. After the inspection is finished, the QC personnel will input the inspection, test, classification, rework and maintenance results and the QC personnel data, through the inspection result input unit 141. Those inspection results will be store in the inspection database 1 so that the registrar 3 can view the QC results through the inspection result check unit 142. The QC personnel can also upload the photographs and data of unqualified products to the inspection database 1 through the upload/download unit 144, for the registrar 3 to download. The QC personnel status check unit 15 is used for checking the QC personnel data so that the registrar 3 can realize the number and background of the QC personnel.

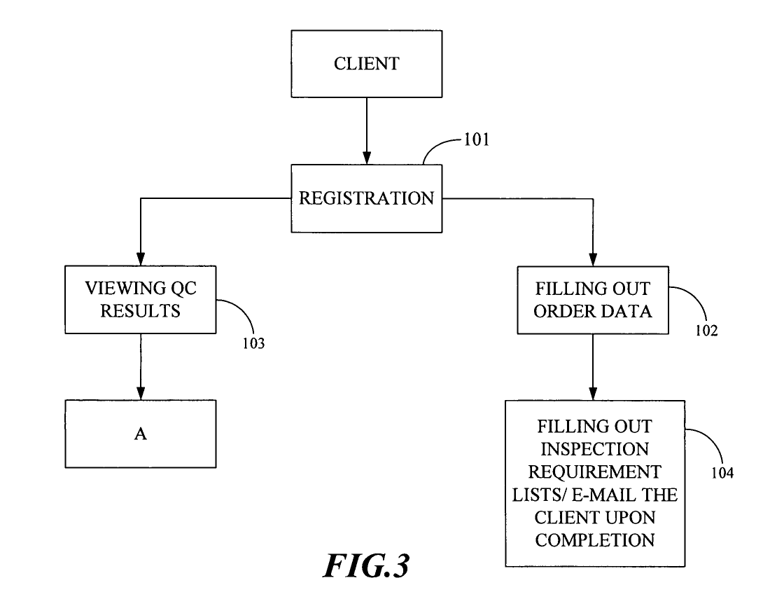

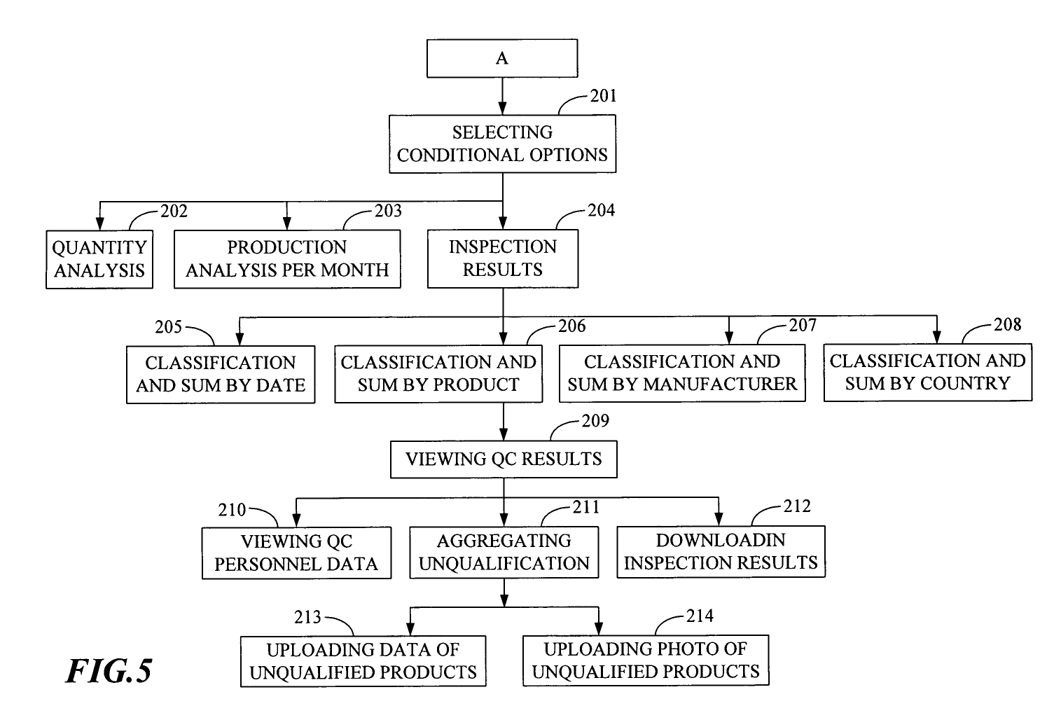

Refer to FIG. 3 and FIG. 5, which are flow charts of the operation, which is performed by the client placing the order, in the QC inspection and maintenance result reporting system of the present invention. When the client placing the order registers into the web server (101) through the Internet, the determination unit of the web server will determine the status of the registrar. If determining him as a client placing the order, the determination unit will define his privilege such that he has two options to select: to fill out order placing data (102), and to view the QC results (103). If the client selects to place the order (102), he can set a sequence of order placing through the order input unit and fill out an inspection requirement list, which contains data such as dates to undertake QC, names, types and quantities of QC articles, QC methods, and names, E-mail addresses and telephone and fax numbers of the client, and data, addresses, contact persons, and telephone numbers of the manufacturers, and addresses for receiving copies of the client data, etc, and the system will inform the client automatically by E-mail when the inspection requirement list is filled out completely (104).

If the client selects to view the QC results (103), he can select conditional options through the selection unit of the web server (201). The conditional options include quantity analysis reports, production analysis reports, and inspection result reports. The quantity analysis report is used for statistics of the quantity of each product in a year (202). The production analysis report is used for statistics of the quantity of all QC products in each month of a year (203).

The inspection result report (204) is divided into four options: to classify and sum by date (205), to classify and sum by product (206), to classify and sum by manufacturer (207), and to classify and sum by country (208). Through the selection unit, the registrar can select the regions (local area) or the clients, which he wishes to view, and then select the dates, products, manufacturers, and optionally countries. Thus, he can view the inspection results (209) through the inspection result check unit. The inspection result includes data such as time to undertake QC, quantity of qualified products, quantity of unqualified products, total quantity, rate of unqualified products, number of QC personnel, QC quantity per day, QC quantity per person, QC quantity per hour, etc. He can view the QC personnel data (210) through the QC personnel status check unit. Also, he can upload the data and photographs of damaged, unqualified products to the inspection database (213, 214) through the upload/download unit, so as to aggregate the data of the unqualified products (211). The client placing the order can download the inspection result reports through the upload/download unit (212), so as to save a backup.

The client, whatever he selects, can view the QC reports made in certain sites only for those products he has place the order.

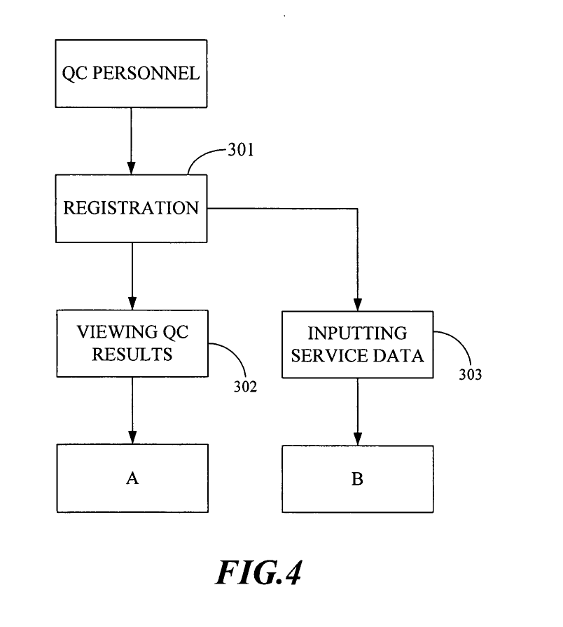

Refer to FIG. 4 to FIG. 6, which are flow charts of the operation, which is performed by the personnel of the QC company, in the QC inspection and maintenance result reporting system of the present invention. When one of the personnel of the QC company registers into the web server (301) through the Internet, the determination unit of the web server will determine the status of the registrar. If determining him as one of the personnel, the determination unit will define his privilege such that he has two options to select: to view the QC results (302), and to input the service data (303). If the registrar selects to view the QC results (302), the operation follows that shown above in FIG. 3 and FIG. 5. For brevity, it is not to be described repeatedly.

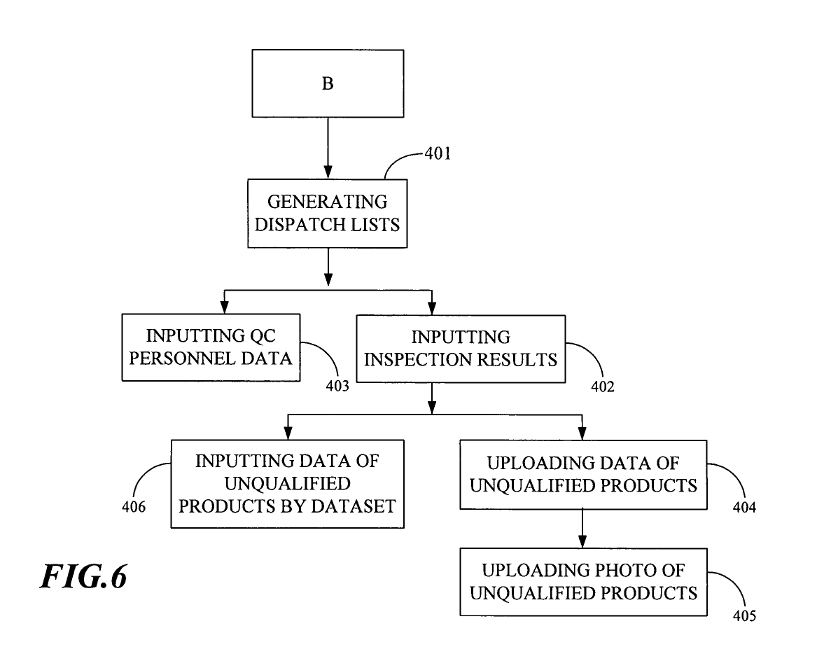

If the registrar selects to input the service data (303), the operation is shown in FIG. 6. He can generate dispatch lists, using the dispatch unit (401), and input the inspection results (402) through the inspection result input unit. The QC personnel can input the inspection results and data of unqualified products by dataset (406), or upload the data and photographs of unqualified products to the inspection database (404, 405) through the upload/download unit. The inspection result includes data such as time to undertake QC, quantity of qualified products, quantity of unqualified products, total quantity, rate of unqualified products, number of QC personnel, QC quantity per day, QC quantity per person, QC quantity per hour, etc. He can also input and store the number, working hours and names of the QC personnel into the inspection database. The data of unqualified products include serial numbers, causes, QC personnel data, and photographs of unqualified products.

The registrar, whatever he selects, can view the QC reports made only in the region of his own.

Moreover, if the registrar is the financial supervisor or boss of the QC company, he can check the finance report for each item he was commissioned to undertake, as well as do the operation shown in FIG. 4 to FIG. 6.

On the other hand, when the determination unit of the web server determines the registrar as a manufacturer under QC, the manufacturer, within his privilege, can view the inspection results as described in FIG. 5.

The QC inspection and maintenance result reporting system provided by the present invention, as compared with conventional technologies, has the following advantages.

1. The system can serve the client placing the order to fill out order placing data by means of the webpages displayed form a remote web server, as the client is connected with the web server through the Internet. In this way, the filled out data may be stored in an inspection database so that the commissioned QC company may undertake inspection, test, classification, rework and maintenance in situ, according to the direction of order placing; the QC results may be stored in the inspection database through the web server, so that the client placing the order may view the rates of unqualified and qualified products and the causes for the unqualification to realize and control the quality of the products, just being connected with the web server through the Internet.

2. The system can upload the analysis reports and photographs to an inspection database, for the registrar to download and view.

3. The system can serve the financial supervisor or boss of the commissioned QC company to view the QC results and the finance reports of the articles through the web server.

The above disclosure is related to the detailed technical contents and inventive features thereof. People skilled in this field can proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A quality control (QC) inspection and maintenance result reporting system comprising an inspection database and a web server, the web server having:
a determination unit, for determining a status of a registrar so as to define a registrar's privilege;
an order input unit, for the registrar to fill out order placing data, the filled out order placing data being stored in an inspection database;
a selection unit, for the registrar to select conditional options;
a data maintenance unit, for generating dispatch lists, for a QC personnel to input and store inspection results and QC personnel data into the inspection database, and for uploading data and photographs of to the inspection database, for the registrar to view and download; and
a QC personnel status check unit, for checking the QC personnel data.

2. The quality control QC inspection and maintenance result reporting system according to claim 1, wherein the inspection database has quantity analysis reports, production analysis reports, inspection result reports, QC personnel data, and analysis reports for the rates for each type of unqualified and qualified product stored therein.

3. The quality control QC inspection and maintenance result reporting system according to claim 1, wherein the data maintenance unit comprises an inspection result input unit, an inspection result check unit, an upload/download unit and a dispatch unit.

4. The quality control QC inspection and maintenance result reporting system according to claim 3, wherein the dispatch unit is used for generating dispatch lists, with which the QC personnel undertakes inspection for products in situ, according to a direction of order input unit.

5. The quality control QC inspection and maintenance result reporting system according to claim 3, wherein the inspection result input unit is used for inputting the QC personnel data, as well as inputting inspection, test, classification, rework and maintenance results.

6. The quality control QC inspection and maintenance result reporting system according to claim 3, wherein the inspection result check unit is used for the registrar to check the QC results.

7. The quality control QC inspection and maintenance result reporting system according to claim 3, wherein the upload/download unit and a dispatch unit is used for uploading and downloading data and photographs of unqualified products.

8. The quality control QC inspection and maintenance result reporting system according to claim 1, wherein QC work includes inspection, test, classification, rework and maintenance.

9. The quality control QC inspection and maintenance result reporting system according to claim 8, wherein the QC work is done for data such as time to undertake QC, quantity of qualified products, quantity of unqualified products, total quantity, rate of unqualified products, QC quantity per person, and QC quantity per hour, for which the results are viewed in association with the QC personnel data and the data and photographs of damaged, unqualified products.
